(19) United States
(12) Patent Application Publication
(10) Pub. No.: US 2007/0059990 A1
(43) Pub. Date: Mar. 15, 2007

(54) Insertion device and endoscopic system

(75) Inventors: Yasuhito Kura, Tokyo (JP); Takahiro Kishi, Yokohama-shi (JP); Akira Suzuki, Uenohara-shi (JP); Akira Taniguchi, Hachioji-shi (JP); Katsutaka Adachi, Tokyo (JP)

Correspondence Address: Thomas Spinelli;Scully, Scott, Murphy & Presser, Suite 300, 400 Garden City Plaza, Garden City, NY, 11530, US

(73) Assignee: OLYMPUS CORPORATION, Tokyo (JP)

(21) Appl. No.: 11/598,424

(22) Filed: Nov. 13, 2006

Related U.S. Application Data
(63) Continuation of application No. PCT/JP05/08914, filed on May 16, 2005.

(30) Foreign Application Priority Data
May 14, 2004 (JP) 2004-145700

(51) Int. Cl. H01R 13/40

(52) U.S. Cl. 439/733.1

(57) ABSTRACT

An insertion device includes a long insert section inserted to a subject body, a propulsion force generation section provided at an outer circumferential surface of the insert section, a rotation section having a guide tube rotation device for rotating the insert section at which the propulsion force generation section is provided about a longitudinal axis, and a rotation control section for controlling the rotation section.

### CROSS REFERENCES TO RELATED APPLICATIONS

This application is a continuation application of PCT/JP 2005/008914 filed on May 16, 2005 and claims benefit of Japanese Application No. 2004-145700 filed in Japan on May 14, 2004, the entire contents of which are incorporated herein by this reference.

### BACKGROUND OF THE INVENTION

1. Field of the Invention

The present invention relates to an insertion device used for introducing an insert section of an endoscope and an endoscopic system including the insertion device.

2. Description of the Related Art

In recent years, an endoscope having an elongated and flexible insert section has been used for inspection or treatment in a medical field. In this endoscope, while the insert section is inserted into a body cavity, without cutting a body, splanchnic organs and the like can be observed, and also, if needed, various therapies and treatments can be performed by introducing a treatment tool into the body cavity via a treatment tool insert channel provided at the insert section. In the endoscope, a bending section is provided on the distal end side of the insert section. The bending section is adapted to perform a bending operation, for example, in up and down directions or right and left directions, by moving back and forward an operation wire coupled to bending pieces that construct the bending section. The operation wire is adapted to move back and forward as a bending knob, for example, provided at the operation section is subjected to a turning operation.

When an endoscopic inspection is performed, the insert section needs to be inserted into a body cavity which is complicatedly tangled. For example, in order to insert the insert section into a hollow organ having a 360 degree loop such as a complicatedly tangled hollow organ like a large bowel, an operator performs a bending operation on the bending section by operating the bending knob and also performs operations at hands including a twist operation on the insert section, thereby introducing the distal end section of the insert section towards the observation target area.

However, it requires a lot of skill to introduce the insert section into a deep section of the complicatedly tangled large bowel without causing a pain on a patient smoothly in a short period of time. In other words, a relatively inexperienced operator may take time for penetration while losing the insert direction when the insert section is inserted into the deep section or may deform the running state of the bowel when the insert section is penetrated into the deep section. For this reason, various proposals have been made to improve the insertability of the insert section.

For example, Japanese Unexamined Patent Application Publication No. 10-113396 discloses a less-invasive propulsion device of a medical device for easily introducing a medical device into a deep section of a living body lumen. In this propulsion device, a rotating member is provided with a rib oblique to the axis direction of the rotating member. For this reason, by performing a rotating operation on the rotating member, a rotating force of the rotating member is converted to a propulsion force by the rib, and thus the medical device coupled to the propulsion device is moved towards the deep section direction with the propulsion force.

### SUMMARY OF THE INVENTION

An insertion device of the present invention includes a long insert section inserted to a subject body, a propulsion force generation section provided at an outer circumferential surface of the insert section, a rotation section having a guide tube rotation device for rotating the insert section at which the propulsion force generation section is provided about a longitudinal axis, and a rotation control section for controlling the rotation section.

### BRIEF DESCRIPTION OF THE DRAWINGS

FIG. 1 is an explanatory diagram for a schematic construction of an endoscopic system according to a first embodiment of the present invention;

FIG. 2 is an explanatory diagram for a construction of an insert section;

FIG. 3 is an explanatory diagram for an insert state of the insert section into a large bowel;

FIG. 4 shows the insert section inserted into the vicinity of a vermiform appendix section;

FIG. 5 is an explanatory diagram for a procedure for causing the insert section to penetrate a treatment tool insert channel provided at the insert section of the endoscope;

FIG. 6 is an explanatory diagram for a state in which the insert section of the endoscope is inserted to the large bowel with use of the insert section as a guide;

FIG. 7 is an explanatory diagram for a schematic construction of an insertion device constructing an endoscopic system according to a second embodiment of the present invention;

FIG. 8 is an outer appearance perspective view of a guide tube container cartridge that constitutes the insertion device;

FIG. 9 is a cross sectional view of the guide tube container cartridge in the longitudinal direction;

FIG. 10 is an explanatory diagram for a schematic construction of an endoscopic system according to a third embodiment of the present invention;

FIG. 11 is an explanatory diagram for a construction of a guide tube arranged on a base end side of an endoscopic capsule according to a modification example of the third embodiment;

FIG. 12 is an explanatory diagram for another construction example of the guide tube container cartridge that constitutes the insertion device;

FIG. 13 is an explanatory diagram for another construction example of the cartridge as a cross sectional diagram taken along the XIII-XIII line of FIG. 14;

FIG. 14 is a cross sectional diagram taken along the XIV-XIV line of FIG. 13;

FIG. 15 is an explanatory diagram for still another construction example of the guide tube container cartridge;

FIG. 16 is an explanatory diagram for a further construction example of the guide tube container cartridge;

FIG. 17 is a front view of the guide tube container cartridge;

FIG. 18 is a cross sectional diagram taken along the XVIII-XVIII line of FIG. 16;

FIG. 19 is an outer appearance perspective view of the construction of the cartridge;

FIG. 20 is a cross sectional diagram taken along the XX-XX line of FIG. 19 including an enlarged view of a holding member;

FIG. 21 is a top view of a cartridge main body in the state in which the guide tube is contained;

FIG. 22 is an explanatory diagram for a schematic construction of an endoscopic system according to a fourth embodiment of the present invention;

FIG. 23 is an explanatory enlarged view for a construction of an operation section of an endoscope in the endoscopic system;

FIG. 24 is an explanatory diagram for a schematic construction of a mechanism section of a guide tube rotation device in an insertion device that constructs the endoscopic system according to the fourth embodiment; and

FIG. 25 is a time chart diagram showing an example of a control pattern for a rotating speed and a rotating direction of the guide tube.

### DESCRIPTION OF THE PREFERRED EMBODIMENTS

Hereinafter, embodiments of the present invention will be described with reference to the drawings.

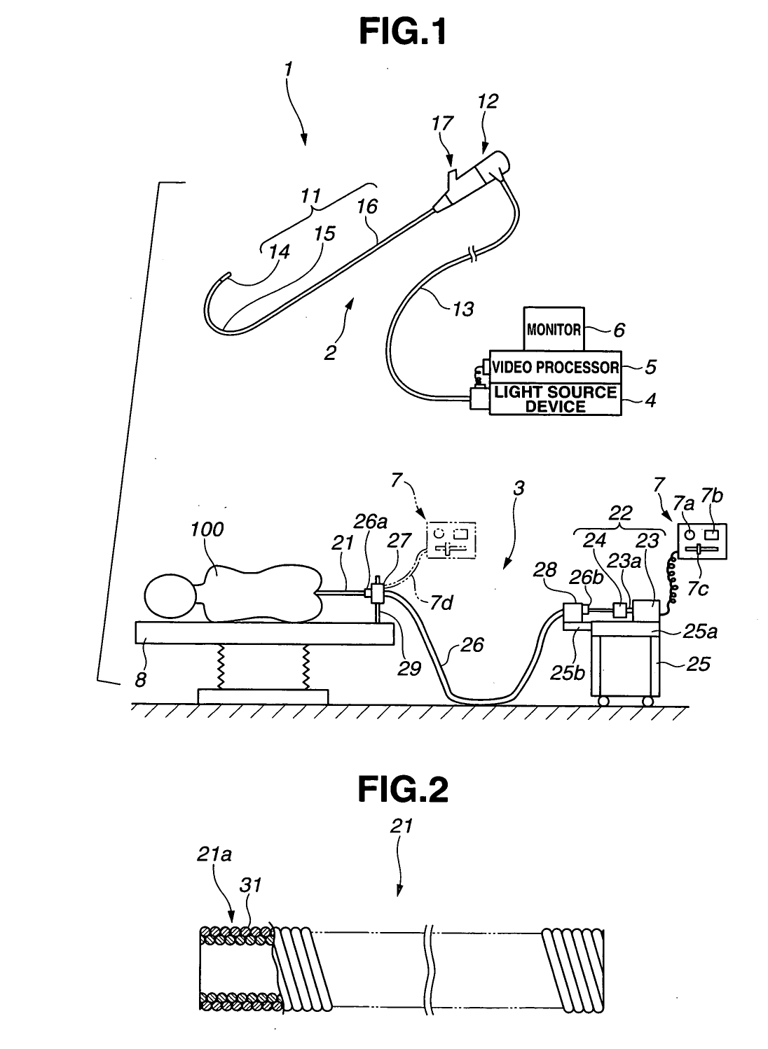

A first embodiment of the present invention will be described while referring to FIGS. 1 to 6.

As shown in FIG. 1, an endoscopic system 1 according to this embodiment is a medical device and is mainly composed of an endoscope 2 having an observation section, and an insertion device 3.

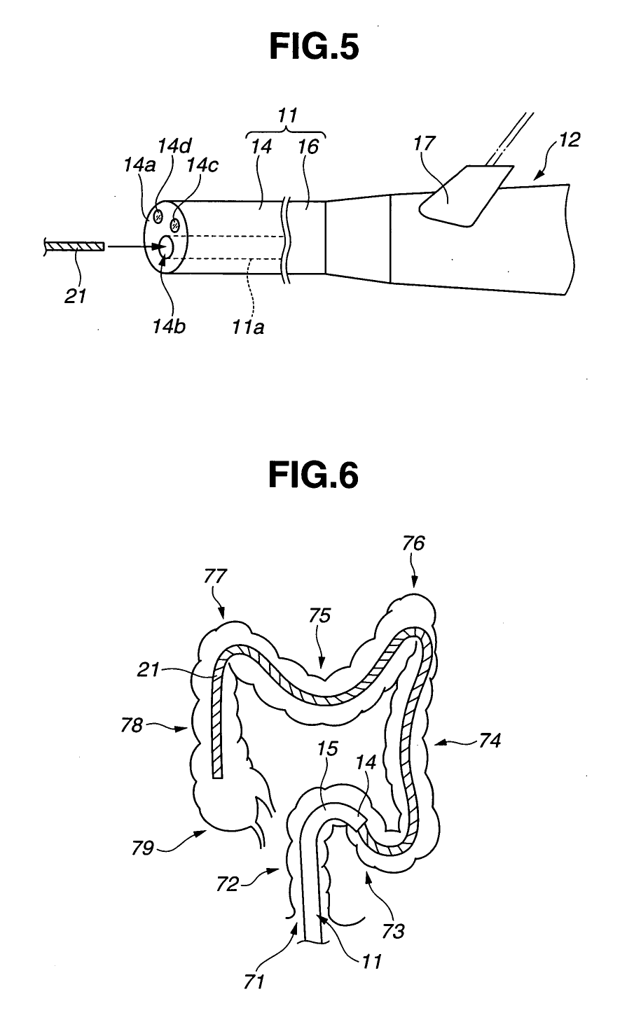

The endoscope 2 is constructed to include an endoscope insert section (hereinafter, referred to as insert section) 11, an operation section 12 arranged on the base end side of the insert section 11, and the universal code 13 extending from the side section of the operation section 12. The insert section 11 is provided with, in the order from its distal end side, a distal end rigid section 14, a bending section 15 constructed to freely bend in the up, down, left, and right directions, for example, and a flexible tube section 16 having a flexibility, which are adjacent one another. The operation section 12 of the endoscope 2 has a treatment tool insert opening. The treatment tool insert opening 17 is in communication with a treatment tool insert channel (refer to reference numeral 11a of FIG. 5) for causing a treatment tool provided inside the insert section 11 (not particularly shown in the drawing) to penetrate.

The endoscope 2 is provided with a light source device 4, a video processor 5, and a monitor 6 as external devices. The light source device 4 supplies the endoscope 2 with illumination light. The video processor 5 has a signal processing circuit for supplying a driver signal for driving an image pick up element (not particularly shown in the drawing) provided at the endoscope 2 and converting an electrical signal transmitted from the image pick up element through photoelectric conversion to a video signal, the generated video signal being output to the monitor 6. On a screen of the monitor 6, an endoscopic image is displayed through the reception of the video signal output from the video processor 5.

The insertion device 3 is mainly constructed of a guide tube 21 functioning as an insert section to be inserted to a subject body as well as a guide member for guiding the insert section 11, and a guide tube rotation device 22.

The guide tube rotation device 22 includes a motor 23 functioning as a rotation section and a guide tube position fix section 24. The motor 23 rotates the guide tube 21 about the guide tube longitudinal axis (hereinafter, referred to as about the axis) in a predetermined direction. The motor 23 is arranged on a table 25a of a rotation device cart (hereinafter, abbreviated as cart) 25. The cart 25 is located near a bed 8, for example, on which a patient gets lying down. To be specific, the motor 23 is fixed to a predetermined fixing member (not shown in the drawing) on the table 25a. In this case, a motor axis 23a of the motor 23 is set so as to be parallel to an upper frat surface of the table 25a of the cart 25.

The guide tube position fix section 24 is integrally fixed to the motor axis 23a of the motor 23. To the guide tube position fix section 24, a base end side terminal section the guide tube 21 functioning as one end terminal is detachably attached. In sequence, in the state in which the guide tube 21 is attached, when the motor 23 is put in a drive state, the motor axis 23a rotates. In the result, the guide tube 21 attached to the guide tube position fix section 24 integrally fixed to the motor axis 23a also rotates about the axis.

It should be noted that the guide tube 21 is covered by a protection tube 26 made of a tubular member. The protection tube 26 prevents the guide tube 21 from directly touching a floor or the like in an operation room. The protection tube 26 has an inner hole, to which the guide tube 21 is loosely fitted. Both end sections. 26a and 26b of the protection tube 26 are respectively detachably attached and fixed to protection tube holding members 27 and 28. Herein, the one protection tube holding member 27 is arranged via a height position adjustment stand 29 enabling on the bed 8, for example. Whereas, the other protection tube holding member 28 is arranged at a position opposing the motor 23 on a table 25b provided at the cart 25. Instead of the protection tube 26, for example, a concave member in a rain gutter shape or the like whose one surface in the longitudinal direction is opened and the entirety of which has a flexibility may be arranged.

To the guide tube rotation device 22, a rotation control box 7 having a control circuit for performing a drive control on the motor 23, plural operation members and the like, and thus functioning as a rotation control section for performing a rotation control on the guide tube 21 is connected.

Inside the rotation control box 7, as described above, a control circuit (not shown in the drawing) for performing the drive control on the motor 23. On an outside panel of the rotation control box 7, various operation members for performing the drive control on the motor 23 are arranged. Examples of the operation members includes a rotation on/off operation member 7a for performing, for example, an on/off operation on the rotation drive control the motor 23, a rotation normal/reverse switching operation member 7b for switching a rotation direction of the motor 23, a speed adjusting operation member 7c for adjusting a rotation speed of the motor 23, and the like.

The rotation on/off operation member 7a is an operation member to be used for arbitrarily performing the on or off operation of the rotation state of the motor 23 (the guide tube 21) in accordance with the insert state of the guide tube 21 and the state of a patience 100 when the endoscopic system 1 is used. The rotation on/off operation member 7a is adapted to perform a control for stopping the rotation of the motor 23 (the guide tube 21) temporarily, a control for resuming the rotation, and the like.

The rotation normal/reverse switching operation member 7b is an operation member to be used for performing a normal/reverse rotation control on the rotation direction when the endoscopic system 1 is used. When the inserted the guide tube 21 is removed, the rotation normal/reverse switching operation member 7b performs an operation for causing the motor 23 to reversely rotate to reverse the guide tube 21. Also, during the insert operation of the guide tube 21, for example, when a stuck is occurred, in order to eliminate this stuck, the motor 23 is temporarily subjected to the reverse rotation state to reverse the guide tube 21. Then, when the guide tube is inserted again, the reverse rotation state is switched to the normal rotation state.

The speed adjusting operation member 7c is an operation member to be used for performing a rotation speed control on the motor 23 when the endoscopic system 1 is used. The rotation speed control on the rotation speed of the motor 23, that is, the rotation speed of the guide tube 21 can be arbitrarily adjusted in accordance with an inspection time, a state of the inside of a body lumen such as a bowel as an inspection target of the patience 100, and the like.

It should be noted that regarding modes of the respective operation members 7a, 7b, and 7c, for example, in FIG. 1, the operation member 7a is made of a rotating operation member, the operation member 7b is made of a push button operation member, and the operation member 7c is made of a sliding operation member. However, the modes of the operation members are not limited to the above and various operation members of widely and generally used modes may be adopted.

As shown in FIG. 2, the guide tube 21 is a spiral tube made with consideration on the penetrating property into the body cavity. The guide tube 21 is formed, for example, by winding a metal wire 31 which is made of stainless steel with a predetermined diameter in spiral by two layers so as to have a predetermined flexibility. The outer front surface of the guide tube 21 has a spiral section 21a functioning as a propulsion force generation section which is formed of a surface of the metal wire 31. It should be noted that the outer diameter size of the guide tube 21 is set so as to be penetrated into the treatment tool insert channel of the endoscope 2.

It should be noted that the guide tube 21 may be formed by winding into plural threads, for example, four threads. Also, when the metal wire 31 is would in spiral, various characteristics of the guide tube 21 can be set by changing a degree of adhesion between the metal wires and changing a degree of spiral.

Effects of the endoscopic system 1 constructed in the above-mentioned manner will be described hereinafter.

A description will be given of a preparation procedure for inserting the guide tube 21 to a large bowel.

In order to insert the insert section 11 of the endoscope 2 to a vermiform appendix section of the large bowel, for example, a medical associate (abbreviated as staff) prepares the protection tube 26 and the guide tube 21 having a predetermined insertability. Next, the staff respectively fixes end sections of the protection tube 26 to the protection tube holding members 27 and 28. Then, the staff causes the guide tube 21 to penetrate to an inner hole of the protection tube 28. After that, the base end section of the guide tube 21 protruding from the protection tube 26 is attached to the guide tube fix section 24 that is fixed to the axis 23a of the motor 23. In addition, the distal end section of the guide tube 21 is arranged, for example, on the bed or the stand 29. As a result, the preparation for causing the guide tube 21 to be penetrated in the large bowel is completed. Also, in addition to the preparation of the insertion device 3, the preparations for the endoscope 2, the light source device 4, the video processor 5, and the monitor 6 are also conducted.

A procedure for inserting the guide tube 21 to the large bowel will be described.

First of all, as shown in FIG. 1, an operator (not shown in the drawing) grasps the distal end side section of the guide tube 21 and inserts the distal end section of the guide tube 21 into the large bowel from an anus of the patience 100 lying on the bed 8. Then, the spiral section 21a provided on the outer front surface of the guide tube 21 contacts the bowel wall. At this time, the contact state between the spiral section 21a formed at the guide tube 21 and the bowel wall fold corresponds to a relation between a male thread and a female thread.

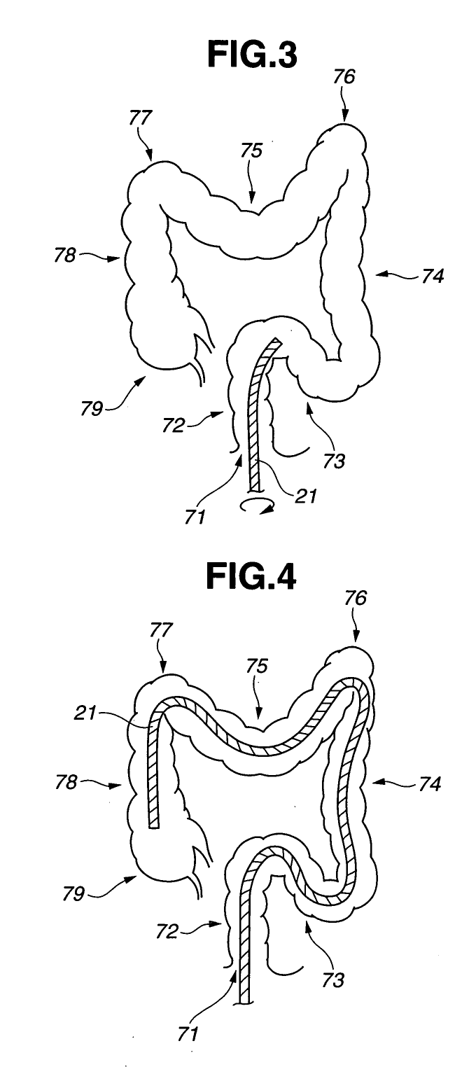

In this contact state, the motor 23 of the guide tube rotation device 22 is put in the rotation drive state. Then, the guide tube position fix section 24 starts rotating. Then, the base end section of the guide tube 21 attached to the guide tube position fix section 24 performs the predetermined rotation. This rotation is transmitted from the base end section to the distal end section. In the result, as shown by an arrow of FIG. 3, the guide tube 21 is put in the state of rotating about the axis such that the spiral section 21a of the guide tube 21 moves from the base end side the distal end section.

In the result, the guide tube 21 moves forward to the contact part between the spiral section 21a of the rotating guide tube 21 and the bowel wall fold as if the male thread moves with respect to the female thread, and accordingly the propulsion force is generated. Then, the guide tube 21 moves forward by the propulsion force to the deep section in the large bowel. At this time, the operator may perform operations at hand so as to push forward to the grasping guide tube 21.

The guide tube 21 inserted from the anus 71 moves forward, with the propulsion force and the operations at hands of the operator, from an intestinum rectum 72 to a sigmoid colon 73. After that, as shown in FIG. 3, the distal end section of the guide tube 21 reaches the sigmoid colon 73. At this time, the contact length between the spiral section 21a of the guide tube 21 and the bowel wall becomes long. Therefore, in the state in which only a part of the spiral section 21a contacts a fold of the sigmoid colon 73 or the guide tube 21 is complicatedly bending, the stable propulsion force can be obtained. In addition, the guide tube 21 has a sufficient flexibility, so the sigmoid colon 73, which easily changes its position, smoothly moves forward along the bowel wall without changing the running state.

After that, the guide tube 21 in the rotating state passes the sigmoid colon 73, and thereafter smoothly moves forward along the walls of a bending section as a boundary between the sigmoid colon 73 and a descending colon section 74 with a low mobility, a splenic flexure 76 as a boundary between the descending colon section 74 and a transverse colon section 75 with a high mobility, and a hepatic flexure 77 as a boundary between the transverse colon section 75 and an ascending colon 78. Then, as shown in FIG. 4, without changing the running state of the large bowel, the distal end section of the guide tube 21 reaches, for example, the vicinity of a vermiforn appendix section 79 functioning as the target area.

If the operator judges that the guide tube 21 has reached the vicinity of the vermiform appendix section 79, on the basis of an instruction from the operator, the staff operates the rotation on/off operation member 7a of the rotation control box 7 to switch the rotation drive state of the motor 23 of the guide tube rotation device 22 to the off state.

After that, on the basis of an instruction from the operator, the staff removes the base end section of the guide tube 21 protruding from the protection tube 26, from the guide tube position fix section 24. After that, the guide tube 21 is removed from the protection tube 26. After that, the procedure shifts to the insertion of the insert section 11 of the endoscope 2 into the large bowel.

It should be noted that during the insertion operation of the guide tube 21 described above, for example, there are some cases in which the distal end section of the guide tube 21 is trapped by a ramp of the bowel, a small recess, or the like, the guide tube 21 is prevented from smoothly moving forward.

In such a case, the operator operates the rotation normal/reverse switching operation member 7b the rotation control box 7 appropriately, to perform a rotation operation to set the rotation direction of the guide tube 21 reverse. Then, the guide tube 21 has a reverse rotation with respect to the rotation direction during the forward movement, whereby the guide tube 21 is moved back. With this construction, the trap of the distal end section of the guide tube 21 is eliminated. After that, the guide tube 21 is moved back to some extent, the rotation normal/reverse switching operation member 7b of the rotation control box 7 is operated again, thereby switching the rotation direction of the guide tube 21 to the forward movement direction. As a result, the position of the distal end section of the guide tube 21 is slightly shifted in position in the bowel, and therefore, the forward movement is resumed without having the distal end section trapped.

In addition, when a fine operation is performed to move the guide tube 21 forward and back, by operating a speed adjustment operation member 7e of the rotation control box 7, it is also possible to rotate the guide tube 21 at a lower speed than that of the normal forward movement.

In this manner, by using the respective operation members 7a, 7b, and 7c of the rotation control box 7 to appropriately change the rotation direction, the rotation speed, and the like of the guide tube 21, the guide tube 21 can be finally moved up to the desired area while arbitrarily moving forward and back in the body cavity.

A procedure for inserting the insert section 11 of the endoscope 2 into the large bowel will be described.

First of all, the operator inserts the base end section of the guide tube 21 removed from the protection tube 26 to the distal end opening 14b arranged on a distal end surface 14a of the distal end rigid section 14. After that, the guide tube 21 is inserted to the operation section 12 side via a treatment tool insert channel 11a in communication with the distal end opening 14b. After that, the base end section of the guide tube 21 protrudes, as represented by a dot and dash line in the drawing, from the treatment tool insert opening 17 provided at the operation section 12. Reference numeral 14b denotes an observation window and reference numeral 14c denotes an illumination window.

Next, the operator sets the endoscope 2 in the observation available state when it is confirmed that the guide tube 21 protrudes from the treatment tool insert opening 17 by a predetermined amount in order to insert the insert section 11 into the large bowel. After that, in the state in which the guide tube 21 is penetrated in the treatment tool insert channel 11a, the operator inserts the distal end rigid section 14 that constitutes the insert section 11 from the anus 71. At this time, an endoscopic image captured by the image pick up element through the observation window 14d provided at the distal end surface of the distal end rigid section 14 is displayed on a screen of the monitor 6.

Herein, the operator checks, on the screen of the monitor 6, the extending direction of the guide tube 21 penetrated into the large bowel. After that, while the operator performs the operation for bending the bending section 15, the operation for twisting the insert section 11, and the like, as shown in FIG. 6, the distal end rigid section 14 of the insert section 11 is inserted into the deep section in the large bowel. At this occasion, the guide tube 21 previously penetrated in the large bowel, the insert section 11 functions as a mark for the insertion direction. In sequence, without losing the insertion direction, the operator can insert the distal end rigid section 14 of the insert section 11 to the vicinity of the vermiform appendix section 79 smoothly.

When the operator confirms that on the basis of the endoscopic image displayed on the screen of the monitor 6, the insert section 11 reaches the vicinity of the vermiform appendix section 79 that is the target area, the procedure shifts to the endoscope inspection in the large bowel. At this time, the operator pulls back the insert section 11. At this time, the guide tube 21 is penetrated in the treatment tool insert channel 11a or the guide tube 21 is previously removed from the treatment tool insert channel 11a .

The above-mentioned actions will be briefly described. The distal end section of the guide tube 21 penetrates up to the target area in the large bowel. After that, an area of the guide tube 21 outside the body is penetrated to the treatment tool insert channel 11a of the endoscope 2. After that, the insert section 11 with the guide tube 21 penetrated in the treatment tool insert channel 11a is inserted into the large bowel. At this time, through the observation window 14d of the endoscope 2, while observing the guide tube 21 in the large bowel, the insert section 11 is inserted to the deep section. As a result, the operator can perform an appropriate bending operation and twisting operation without losing the insertion direction for the insert section 11. In sequence, the insert section 11 can be inserted to the deep section of a hollow organ in the body cavity (the large bowel and the like) smoothly in a short period of time.

As described above, as the spiral section 21a is provided at the outer front surface of the guide tube 21, in the state in which the guide tube 21 is inserted, for example, into the large bowel, the contact state between the spiral section 21a and the bowel wall fold becomes a so-call male thread and female thread relation. In this contact state, the motor 23 constructing the guide tube rotation device 22 is rotated and driven, thereby rotating the guide tube 21 in the axis direction. In the result, as the rotation force is converted to the propulsion force, the guide tube 21 is rotated and can be moved to the deep section of the large bowel such that the male thread moves with respect to the female thread.

Furthermore, the endoscopic system 1 is provided with the rotation control box 7 for switching the on/off state of the rotation operation of the guide tube 21 and controlling the rotation direction, the rotation speed, and the like thereof. In sequence, for example, when during the insertion of the guide tube 21, the distal end area is trapped by a fold of the bowel, a small recess, or the like, the guide tube 21 and the forward movement is prohibited, the operation member 7a, 7b, 7c, and the like of the rotation control box 7 are operated. In the result, the cause of prohibiting the forward movement of the guide tube 21 can be easily eliminated. In sequence, it becomes easy for the distal end area of the guide tube 21 to smoothly reach the desired area in the body cavity with safety and reliability.

It should be noted that according to this embodiment, the description has been given while the hollow organ for the insertion of the insert section 11 of the endoscope 2 refers to the large bowel, but the hollow organ for the insertion of the insert section 11 is not limited to the large bowel and may be, for example, the hollow organ from the buccal cavity to the esophagus, the stomach, and the small bowel.

Also, according to this embodiment, the rotation control box 7 is arranged so as to be directly connected to the guide tube rotation device 22 but, for example, as indicated by the dotted line in FIG. 1, the rotation control box 7 may be arranged in the vicinity of the bed 8. In this case, the connection cable 7d from the rotation control box 7 is constructed to be penetrated inside the protection tube 26 via the protection tube holding member 27 to be connected to the guide tube rotation device 22. At this time, inside the protection tube 26, separately from the duct path that the guide tube 21 penetrates, another duct path that the connection cable 7d penetrates is provided. In this manner, if the rotation control box 7 is arranged in the vicinity of the bed 8, the box can be arranged in the vicinity of the patience 100, and therefore the operator can reliably and easily perform the rotation control on the guide tube 21.

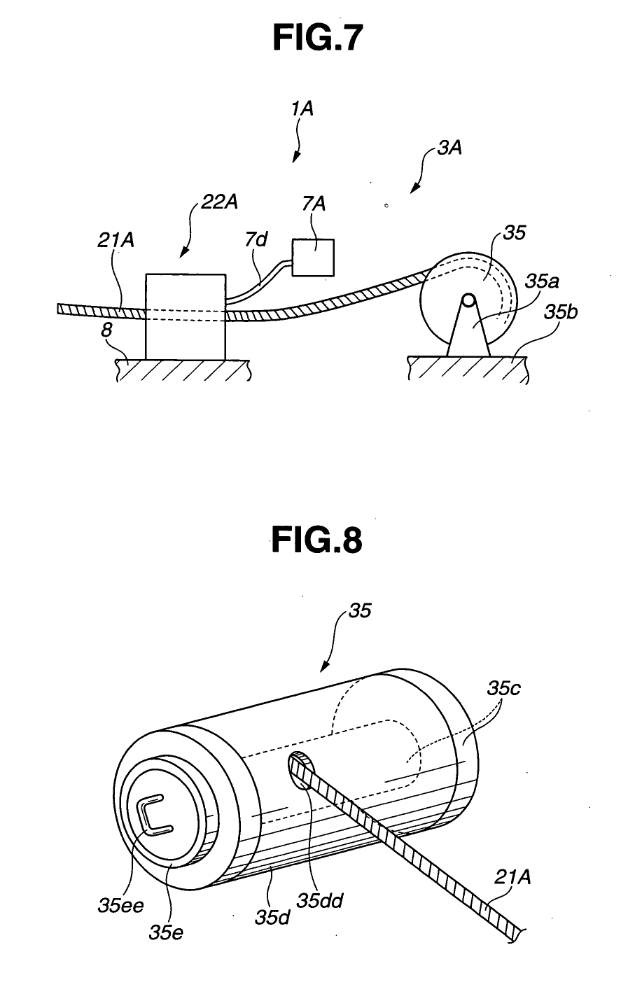

While referring to FIGS. 7 to 9, a second embodiment of the present invention will be described.

In the endoscopic system according to this embodiment, the construction of the insertion device is slightly different. According to the first embodiment described above, the guide tube 21 is adapted to have a small diameter to be used while being penetrated in the treatment tool insert channel of the endoscope 2. Whereas the guide tube 21A that is an insert section shown in FIG. 7 of this embodiment is inserted alone in the body cavity, and then this is used as a guide to be along the guide tube 21A for inserting the endoscope 2 into the body cavity. Therefore, the guide tube 21A of this embodiment has a larger diameter than that of the guide tube 21 the first embodiment described above.

Regarding other aspects, the same constructions as those of the first embodiment are not shown and the description thereof will be omitted, only different points will be described below. In addition, for the insertion device 3A according to this embodiment, the same reference numerals are given to substantially the same constructions as those of the first embodiment and the detailed description thereof will be omitted.

In the insertion device 3A of the endoscopic system according to this embodiment, the guide tube rotation device 22A is arranged on the bed 8 or in the vicinity of the bed 8, which is different from the first embodiment described above.

Therefore, as shown in FIG. 7, the insertion device 3A is mainly constructed of the guide tube rotation device 22A, the rotation control box 7, a guide tube containing cartridge (hereinafter, simply abbreviated as cartridge) 35, and the like. The guide tube rotation device 22A is arranged on the bed 8 or in the vicinity of the bed 8. The guide tube rotation device 22A includes a motor for rotating the guide tube 21A as a driving source (not shown in the drawing) and the like. The rotation control box 7 is a rotation control section for perform the rotation control on the guide tube 21 A, and is connected to the guide tube rotation device 22A. When contained in the cartridge 35, the guide tube 21 A is in the state of being wound.

The rotation control box 7 includes a control circuit for performing a drive control on the motor of the guide tube rotation device 22A and the like and a plurality of operation members. Herein, the plurality of operation members are the same as the operation member 7a, 7b, and 7c shown in the first embodiment described above.

The guide tube rotation device 22A and the rotation control box 7 are electrically connected to each other via a cable 7b. Exchange or the like of the control signal between the guide tube rotation device 22A and the rotation control box 7 is conducted via the cable 7b.

The cartridge 35 has its entity formed, for example, in a cylindrical shape. The cartridge 85 is supported about the axis in the predetermined axis so as to be detachably fixed and arranged to the cartridge setting table 35a. The cartridge setting table 35a is arranged stably on a predetermined fixing member 35b such as a floor surface.

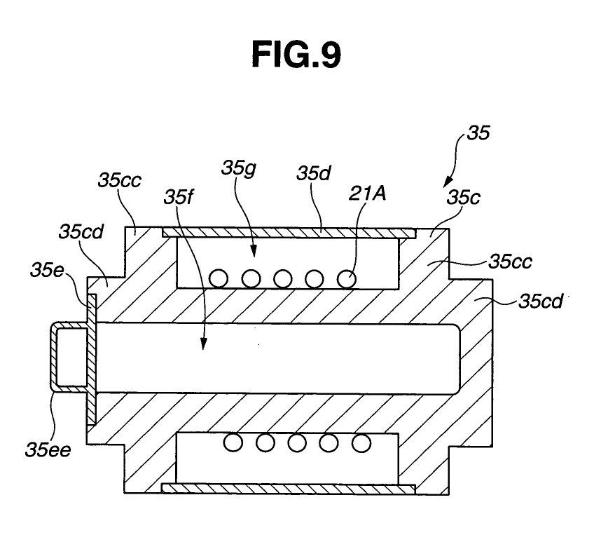

As shown in FIGS. 8 and 9, the cartridge 35 is mainly constructed of a cartridge main body 35c, a cover member 35b, a lid member 35e, and the like. The cartridge main body 35c is formed to include a guide tube winding member 35g and a guide tube containing member 35f. The cover member 35b covers an outer surface of the guide tube winding member 35g. The lid member 35e covers an opening section of the guide tube containing member 35f.

The cartridge main body 35c has a shape of a hollow cylinder as a whole. A center area of the cartridge main body 35c includes the guide tube containing member 35f formed of a hollow section having an opening section at one side edge. At the opening section of the guide tube containing member 35f, the lid member 35e is detachably attached by way of, for example, a screw method, a fitting method, or the like. A knob section 35ee for attaching and detaching the lid section is integrally formed to the lid section 35e. It should be noted that the lid member 35e is formed of a member that is made of a flexible material, for example, plastic resin or rubber.

Both the end sections of the cartridge main body 35c in the axis direction has the flange section 35cc that forms the guide tube winding member 35g. The flange section 35cc has a small diameter section 35cd having a smaller diameter than the maximum outer diameter area of the flange section, extending outward in the axis direction. After that, a peripheral section of the small diameter section 35cd is arranged on a predetermined area of the cartridge setting table 35a so as to be detachably attached. That is, the small diameter section 35cd performs a role of an axis area for supporting the cartridge 35 with respect to the cartridge setting table 35a so as to freely turn about the axis.

In substantially the center of the trunk section of the cartridge main body 35c, the groove shaped guide tube winding member 35g with a cross section formed like a recess. In the guide tube winding member 35g, the guide tube 21A is wound and contained. The cartridge main body 35c has the cover member 35b integrally arranged. The cover member 35b is provided across the entire periphery so as to cover an outer surface on the outer peripheral side of the guide tube winding member 35g. The cover member 35b is formed integrally to the cartridge main body 35c by way of, for example, adhesion, welding or other means.

At a predetermined area of the cover member 35b, a through hole 35dd for pulling out the guide tube 21A wound to be contained inside thereof is provided. The through hole 35dd is formed to have a larger diameter than that of the guide tube 21A.

The action of the endoscopic system using the insertion device 3A constructed in this manner is as follows.

First of all, a preparation procedure for inserting the guide tube 21A into the large bowel is as follows.

As shown in FIG. 1, in order to cause the insert section 11 of the endoscope 2 to be communicated, for example, up to the vermiform appendix section of the large bowel, first of all, the staff conducts a setting preparation of the insertion device 3A. That is, the cartridge 35 containing the guide tube 21A previously wound is prepared. After that, the cartridge 35 is set at a predetermined position of the cartridge setting table 35a.

Next, the staff pulls the distal end section of the guide tube 21A from the through hole 35dd of the cartridge 35 to be arranged at a predetermined position inside the guide tube rotation device 22A. As a result, preparation for causing the guide tube 21A to penetrate into the large bowel is completed. In addition, along with the preparation of the insertion device 3A, the endoscope 2, the light source device 4, the video processor 5, and the monitor 6 are also prepared.

Next, the operator inserts the guide tube 21A to the large bowel. This procedure is substantially the same as the first embodiment described above. In other words, the operator inserts the distal end section of the guide tube 21 A from the anus of the patient on the bed 8 into the large bowel. In this state, the operator operates the rotation on/off operation member 7a of the rotation control box 7A to put a motor of the guide tube rotation device 22A (not shown in the drawing) in the rotation drive state. Then, the guide tube 21A constructed as shown in FIG. 2 starts rotating in a predetermined way about the axis such that the spiral section 21a of the guide tube 21A moves from the base end side to the distal end section. Thus, the guide tube 21A moves forward to the deep section in the large bowel through the propulsion force generated by itself. Herein, as the guide tube 21A moves forward, whereby the guide tube 21A is pulled out from the through hole 35dd of the cartridge 35. In the result, the cartridge 35 rotates on the cartridge setting table 35a.

After that, the guide tube 21A reaches, in the end, as shown in FIG. 6, for example, the vicinity of the vermiform appendix section 79 that is the target area. At this time, the operator judges that the guide tube 21A reaches the vicinity of the vermiform appendix section 79. Herein, the operator issues instructions to the staff. Then, the staff operates the rotation on/off operation member 7a of the rotation control box 7A, whereby the rotation drive state of the motor of the guide tube rotation device 22A is put into the off state.

It should be noted that during the operation for inserting the guide tube 21A to the large bowel, as described in the first embodiment, the distal end area of the guide tube 21A is trapped by the bowel fold, the small recess, or the like, and therefore smooth forward movement may be disturbed in some cases. The measure at this time is completely the same as that of the first embodiment described above. That is, the operator appropriately operates the operation members 7a, 7b, and 7c of the rotation control box 7A to control the rotation direction, the rotation speed, and the like of the guide tube 21A. With this construction, the guide tube 21A appropriately moves forward and back in the body cavity and eventually reaches the desired area.

Thus, the guide tube 21A is in a state of being placed between the anus to the vicinity of the vermiform appendix, for example, that is the desired area. In this state, the insert section 11 of the endoscope 2 is inserted into the large bowel. In prior to this, firstly, the operator sets the endoscope 2 into an observable state.

In the state in which the guide tube 21A is placed in the body cavity, the operator inserts the distal end rigid section 14 that constitutes the insert section 11 from the anus 71 into the large bowel. Then, the endoscopic image is displayed on the screen of the monitor 6.

Herein, the operator checks the extending direction of the guide tube 21A inserted into the large bowel on the screen of the monitor 6. After that, the operator performs the operation of bending the bending section 15 of the endoscope 2, the operation of twisting the insert section 11, and the like, thereby inserting the distal end rigid section 14 of the insert section 11 into the deep section of the large bowel. At this occasion, the guide tube 21A previously inserted into the large bowel functions as a guide for showing the direction of inserting the insert section 11. In sequence, the operator can smoothly insert the distal end rigid section 14 of the insert section 11 to the vicinity of the vermiform appendix section 79 without losing the insertion direction.

The operator checks that the insert section 11 reaches the vicinity of the vermiform appendix section 79 that is the target area, through the endoscopic image displayed on the screen of the monitor 6. Herein, before performing the endoscope inspection, the operator removes the guide tube 21A. After that, the procedure shifts to the pulling back operation of the insert section 11 to conduct the endoscope inspection on the inside of the large bowel.

It should be noted that the guide tube 21A pulled out of the body cavity is entirely contained in the guide tube containing member 35f from the opening section that is exposed when the lid member 35e of the cartridge 35 is removed. After that, the opening section is closed by the lid member 35e. Then, when the inspection is completed, the cartridge 35 is discarded.

As described above, according to the second embodiment, it is easily applicable to a mode where after the guide tube 21A is inserted into the body cavity alone, the endoscope 2 is inserted into the body cavity while using this as a guide, the guide tube 21A. In sequence, the same effect as that of the first embodiment described above can be attained.

Then, the guide tube 21A that is inserted into the body cavity and then removed is contained in the guide tube containing member 35f provided inside the cartridge 35. After that, a construction in which the cartridge 35 while keeping the contained state can be discarded, that is, a disposable product is employed. Thus, the labor hour for a washing process and the like are omitted, whereby a safety, reliable, and efficient operation can be performed.

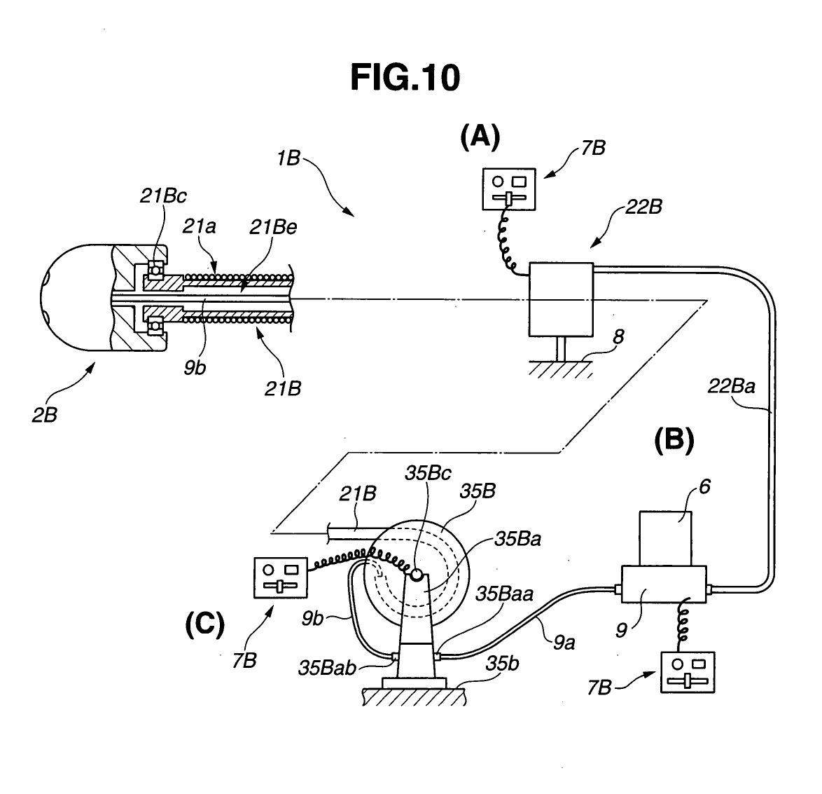

While referring to FIG. 10, the third embodiment of the present invention will be described.

The construction of endoscopic system 1B according to this embodiment is significantly different from the first embodiment and the second embodiment described above. That is, the endoscopic system 1B according to this embodiment shown in FIG. 10 is mainly constructed of an endoscopic capsule 2B, the guide tube 21B functioning as the insert section, the guide tube rotation device 22B, a rotation control box 7B, the cartridge 35B, a system center 9, the monitor 6, and the like.

The endoscopic capsule 2B is constructed to have a small capsule shape. To the distal end of the guide tube 21B, the endoscopic capsule 2B is fixed to be arranged. As the endoscopic capsule 2B is fixed to the distal end, the guide tube 21B corresponds to the insert section 11 of the endoscope 2 according to the first embodiment described above and guides the endoscopic capsule 2B to a desired area in the body cavity. The guide tube rotation device 22B includes a motor (not shown in the drawing) functioning as a drive source for rotating the guide tube 21B. The guide tube rotation device 22B is arranged on the bed 8 or in the vicinity of the bed 8. The rotation control box 7B is the rotation control section for performing the rotation control on the guide tube 21B. The cartridge 35B is the guide tube containing cartridge for containing the guide tube 21B in the wound state. The system center 9 performs the drive control on the endoscopic capsule 2B and various signal processings while receiving a signal from the endoscopic capsule 2B. The monitor 6 displays the endoscopic image or the like while receiving an image signal generated by the system center 9. The signal cables 9a and 9b performs the exchange of various signals between the system center 9 and the endoscopic capsule 2B. The signal cable 9b is caused to penetrate a lumen 21Be of the guide tube 21B.

The endoscopic capsule 2B is constructed to have, although the diagrammatic representation is omitted, an illumination device, an image pickup section formed of electric members like an image pick up element such as a CCD, etc. The signal cable 9b extends from the image pickup section. A suction tube (not shown in the drawing) is arranged so as to be in communication with a suction opening (not shown in the drawing) the distal end section. The suction tube penetrates the lumen 21Be of the guide tube 21B and is connected to a connection section 35Bab provided at a base end of a cartridge setting table 35Ba of the cartridge 35B. The connection section 35Bab is electrically connected to a connection section 35Baa via the base section of the cartridge setting table 35Ba. The signal cable 9a extending from the system center 9 is connected to the connection section 35Baa. As a result, the system center 9 and the endoscopic capsule 2B are electrically connected to each other. In sequence, the system center 9 is adapted to send a predetermined drive control signal via the signal cables 9a and 9b to the endoscopic capsule 2B and receive a signal from the endoscopic capsule 2B.

As described above, the endoscopic capsule 2B is provided at the distal end area of the guide tube 21B. A bearing 21Bc is provided between the distal end area of the guide tube 21B and the endoscopic capsule 2B. With the provision of the bearing 21Bc, the endoscopic capsule 2B is arranged so as to freely turn about the guide tube 21B. In sequence, the rotation force of the guide tube 21B is prevented from being transmitted to the endoscopic capsule 2B. In other words, even when the guide tube 21B rotates, the endoscopic capsule 2B does not rotate together with the rotation of the guide tube.

Also, as described above, the guide tube 21B is a member corresponding to the insert section 11 of the endoscope 2 according to the first embodiment and at the same time, a member for guiding the endoscopic capsule 2B to the desired area in the body cavity. The guide tube 21B is formed of a hollow tube. As described above, the signal cable 9b, the suction tube, and the like are caused to penetrate the lumen. 21Be of the guide tube 21B. In addition, the spiral section 21a having the same construction as shown in FIG. 2 is formed on the outer periphery of the guide tube 21B.

Therefore, by rotating the guide tube 21B, the propulsion force for the forward movement is obtained. After that, with the propulsion force, when the guide tube 21B is moved forward, for example, the endoscopic capsule 2B is prevented from the transmission of the rotation force of the guide tube 21B. For this reason, on the screen of the monitor 6 displays the endoscopic image captured by the endoscopic capsule 2B in the stopped state without rotating. Furthermore, the guide tube 21B has the lumen 21Be which is a sufficiently large space, and thus the signal cable 9b and the like penetrating the lumen 21Be are not rotated along with the rotation of the guide tube 21B.

The basic conduction of the cartridge 35B is substantially the same as the guide tube containing cartridge according to the second embodiment. That is, the cartridge 35B is arranged at a predetermined area of the cartridge setting table 35Ba so as to freely turn about an axis section 35Bc in the predetermined direction (about the axis). The cartridge setting table 35Ba is stably placed on the fixing member 35b such as a floor surface.

It should be noted that constructions of the guide tube rotation device 22B and the rotation control box 7B are substantially the same as those of the first embodiment described above and therefore the detailed description thereof will be omitted.

Also, in order that the rotation control box 7B can be connected to, for example, any of the guide tube rotation device 22B, the system center 9, and the cartridge setting table 35Ba, a connection connector is provided to each of the devices. In sequence, the user can use by connecting the rotation control box 7B to any of the areas of the respective devices.

To be specific, as denoted by reference symbol [A] of FIG. 10, the rotation control box 7B is connected to the guide tube rotation device 22B, as denoted by reference symbol [B] of FIG. 10, the rotation control box 7B is connected to the system center 9, or as denoted by reference symbol [C] of FIG. 10, the rotation control box 7B is connected to the cartridge setting table 35Ba.

Now, a case in which the rotation control box 7B is connected to the system center 9 will be described. In this case, the system center 9 and the guide tube rotation device 22B are connected to each other via a connection cable 22Ba. In sequence, the instruction signal from the rotation control box 7B is transmitted to the guide tube rotation device 22B via the connection cable 22Ba.

Then, a case in which the rotation control box 7B is connected to the cartridge setting table 35Ba will be described. The cartridge setting table 35Ba and the system center 9 are connected to the signal cable 9a for the start. The system center 9 and the guide tube rotation device 22B are connected to each other via the connection cable 22Ba. In sequence, the instruction signal from the rotation control box 7B are transmitted to the guide tube rotation device 22B via the connection cable 9a, the system center 9, the connection cable 22Ba.

In the endoscopic system 1B constructed in this manner according to the third embodiment, for inserting the endoscopic capsule 2B into the body cavity, the guide tube 21B is rotated by the guide tube rotation device 22B, thereby obtaining the propulsion force. Then, the control on the rotation direction, the rotation speed, and the like of a motor (not shown in the drawing) of the guide tube rotation device 22B can be conducted by appropriately operating the operation members of the rotation control box 7B. In sequence, as in the first embodiment and the second embodiment described above, the distal end area of the guide tube 21B, that is, the endoscopic capsule 2B according to this embodiment can reach the desired area in the body cavity safely, reliably, and smoothly.

Also, with the construction in which the rotation control box 7B can be connected to a plurality of devices, the user can appropriately change the position of the rotation control box 7B in accordance with the use. Therefore, the endoscopic system 1B can be operated efficiently.

Furthermore, the rotation control box 7B may be connected to all the areas of [A], [B], and [C] of FIG. 10.

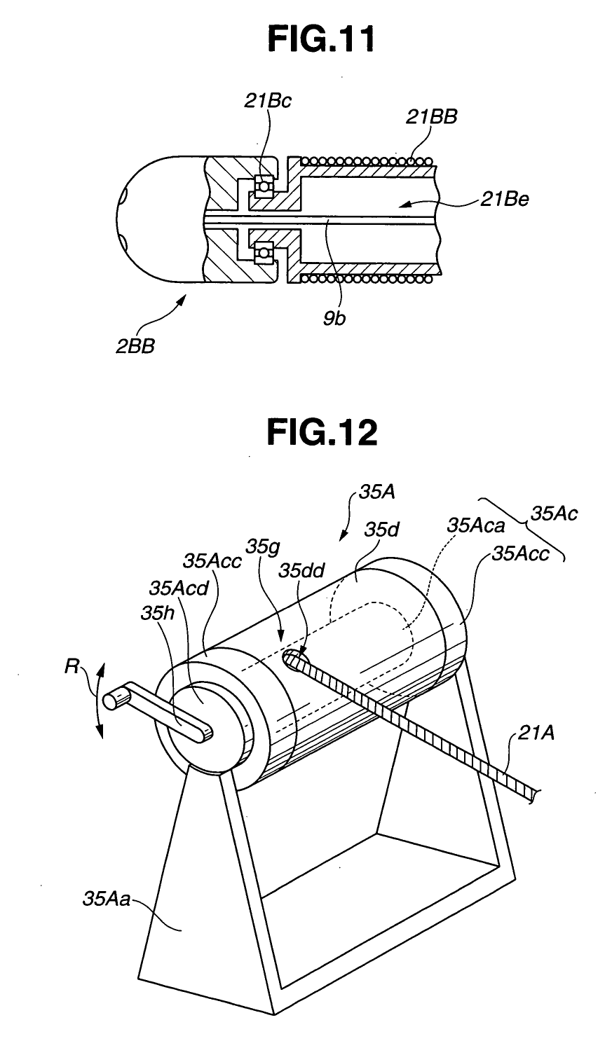

It should be noted that the endoscope capsule and the guide tube according to the third embodiment may also adopt the mode shown in FIG. 11.

The endoscopic system shown in this modification example has substantially the same construction as that of the third embodiment. According to the third embodiment described above, as shown in FIG. 10, the guide tube 21B is formed to have a diameter smaller than that of the endoscopic capsule 2B. On the other hand, the endoscopic capsule 2BB shown in FIG. 11 is formed to have a diameter substantially the same as those of the guide tube 21B and the endoscopic capsule 2B.

In the third embodiment, the guide tube 21B has the small diameter and is accordingly superior in flexibility, thereby forming the guide tube 21B that is more flexible. On the other hand in this modification example, an area where the rotation force of the guide tube 21BB is used as the propulsion force of the endoscopic capsule 2BB can be easily used from the vicinity of the distal end surface of the guide tube 21BB. In sequence, the area where the propulsion force can be obtained when the endoscopic capsule 2BB is inserted into the body cavity is widened to the vicinity of the endoscopic capsule 2BB, whereby the insert operation can be conducted more easily.

On the other hand, the construction of the cartridge for containing the guide tube is not limited to the construction of the above-mentioned embodiment and, for example, various modes shown below are conceivable.

With reference to FIG. 12, other construction examples of the guide tube containing cartridge in the insertion device will be described.

The cartridge 35A according to this embodiment has substantially the same construction as the cartridge 35 of the second embodiment. In the cartridge 35A, instead of using the lid section 35e and the knob section 35ee of the cartridge 35 according to the second embodiment, a handle section 35b for turning a cartridge main body 35Ac is arranged, and the guide tube containing member 35f is unused. This point makes a difference to the cartridge 35.

As shown in the drawing, the cartridge 35A is formed to have a cylinder shape as a whole. The cartridge 35A is arranged in a state of being supported by the axis so as to freely turn by the cartridge setting table 35Aa in the predetermined direction. The cartridge setting table 35Aa is stably placed on the predetermined fixing member such as a floor surface.

The cartridge 35A is mainly constructed of the cartridge main body 35Ac, the cover member 35b, a handle section 35h, and the like. The cartridge main body 35Ac is formed to have the guide tube winding member 35g. The cover member 35b covers the outer surface of the guide tube winding member 35g. The handle section 35h is arranged at one terminal section of the cartridge main body 35Ac.

The cartridge main body 35Ac includes a cylindrical trunk section 35Aca. The guide tube 21 A is wound around the cylindrical trunk section 35Aca. A flange section Acc forming the guide tube winding member 35g is integrally provided to both the ends in the axis direction of the cylindrical trunk section 35Aca. The flange section Acc is formed to have a diameter larger than that of the cylindrical trunk section 35Aca. The flange section 35Acc is set to have a diameter larger than that of the trunk section 35Aca. In the flange section 35Acc, a small diameter section 35Acd having a diameter smaller than the largest outer diameter section of the flange section is extended toward the outside in the axis direction. The peripheral section of the small diameter section 35c d is placed on a predetermined area of the cartridge setting table 35Aa. As a result, the small diameter section 35Acd plays a role of the axis section for supporting the cartridge 35 so as to freely turn about the cartridge setting table 35Aa.

A supporting point of the handle section 35h is fixed to the center axis area on one side of the small diameter section 35Acd. The handle section 35h is formed of an arm section and a handle section. The handle section 35h is fixed and arranged integrally to one end section of the cartridge main body 35Ac. By turning the handle section 35h in the arrow R direction shown in FIG. 12, the entirety of the cartridge 35A can be turned in the same direction.

Around the guide tube winding member 35g provided substantially at the center section of the trunk section of the cartridge main body 35c, the guide tube 21A is wound and contained. The outer surface of the guide tube winding section 35g is covered with the cover member 35b over the entire circumference. The cover member 35b is arranged integrally to the cartridge main body 35c. To be specific, the cover member 35b is formed so as to be integrated to the cartridge main body 35c through, for example, adhesion, welding, or the like.

Furthermore, a through hole 35dd for pulling out the guide tube 21A that is contained in the state of being wound is provided at the predetermined area of the cover member 35b. The through hole 35dd is formed to have a diameter larger than that of the guide tube 21A.

In the cartridge 35A constructed in this manner, when the inspection is completed, by rotate the handle 35h in the predetermined direction, the used guide tube 21A can be would again into the cartridge 35A. After that, when all the distal end area of the guide tube 21A is wound back into the cartridge 35A, the cartridge 35A is discarded.

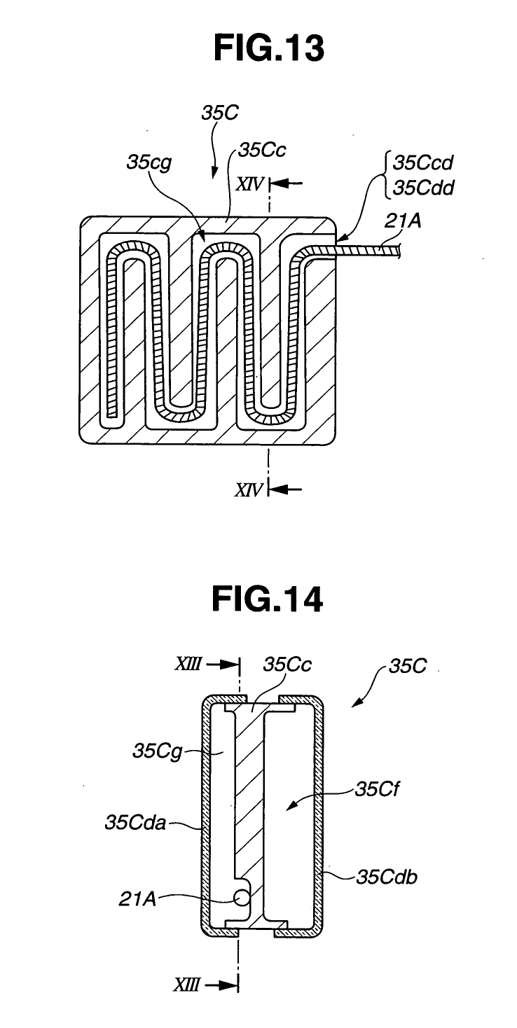

While referring to FIGS. 13 and 14, another construction of the guide tube containing cartridge will be described.

As shown in FIGS. 13 and 14, a cartridge 35C is formed into a rectangular shape as a whole. The cartridge 35C is mainly constructed of the cartridge main body 35Cc and the cover members 35Cda and 35Cdb. The cover member 35Cda and the cover member 35Cdb cover two side surfaces so as to sandwich the cartridge main body 35Cc.

On one side of the cartridge main body 35Cc, a concave groove shaped containing section 35Cg for containing the guide tube 21A is formed. In addition, on the other side thereof, a guide tube containing section 35Cf for containing the used guide tube 21A is formed.

Then, the concave groove shaped containing section 35Cg forms a predetermined space by being covered with the cover member 35Cda. Also, the guide tube containing member 35f forms a predetermined space by being covered with the cover member 35Cdb. The two cover members 35Cda and 35Cdb are arranged so as to be detachably attached to the cartridge main body 35c e.

A through hole 35Cdd for pulling back the guide tube 21A contained in the concave groove shaped containing section 35Cg is formed at the cover member 35Cda that covers the concave groove shaped containing section 35Cg. A notch 35Ccd is formed on the side of the cartridge main body 35Cc corresponding to the through hole 35Cdd.

In the cartridge 35C constructed in this manner, when the inspection is completed, the cover member 35Cdb is removed, and thereafter, the used guide tube 21A is contained inside the guide tube containing section 35Cf, and then the cover member 35Cdb is attached again. After that, the cartridge 35C is discarded.

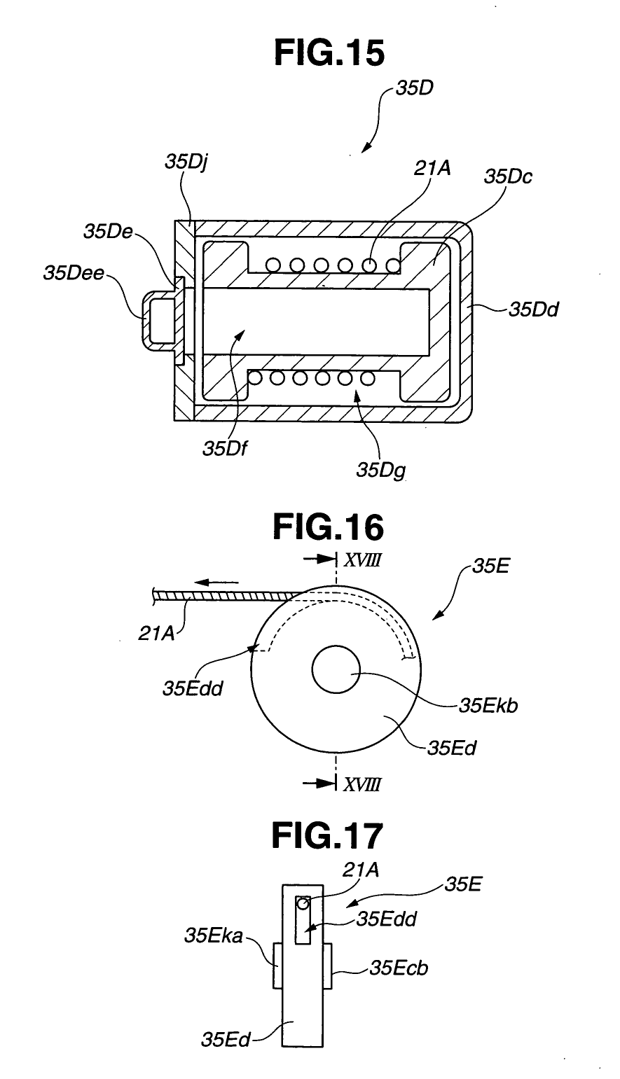

With reference to FIG. 15, still another construction of the guide tube containing cartridge will be described.

As shown in FIG. 15, a cartridge 35D is mainly constructed of a bobbin-shaped cartridge main body 35Dc, a cylinder-shaped outer casing 35Dd for containing the entity of the cartridge main body 35Dc, and a lid member 35Dj.

The cartridge main body 35Dc includes a trunk section for winding the guide tube 21A and a winding stop section provided at both ends of the trunk section. The space defined between the inner wall on the side surface of the outer casing 35Dd and the trunk section of the cartridge main body 35Dc is a guide tube winding section 35Dg. Also, a hollow is formed in the inner center section of the trunk section of the cartridge main body 35Dc. This hollow is a guide tube containing section 35Df for containing the used guide tube 21A.

The outer casing 35Dd has an opening on one side, and inside the outer casing 35Dd, the entirety of the cartridge main body 35Dc is adapted to be contained. The lid member 35Dj is joined to the peripheral section of the opening of the outer casing 35Dd through joining means, for example, adhesion, welding, or the like. It should be noted that the guide tube 21A is wound about the guide tube winding section 35Dg defined between the outer casing 35Dd and the cartridge main body 35Dc. In addition, a through hole not shown in the drawing (hereinafter, referred to as pulling out hole) for pulling out the guide tube 21A wound about the trunk section of the cartridge main body 35Dc is formed at the predetermined area on the side peripheral wall of the outer casing 35Dd.

Substantially at the center section of the lid member 35Dj, a through hole in communication with the guide tube containing section 35Df is formed. The lid member 35De is detachably attached to the through hole. The lid member 35De is detachably attached to the through hole through, for example, a screw method or a fitting method. As a result, the through hole is appropriately openably closed.

The lid member 35De is integrally provided with the knob section 35ee that is used for attachment and detachment. It should be noted that the lid member 35De is made of a flexible material member, for example, plastic resin, rubber, or the like.

In the cartridge 35D constructed in this manner, when this is used for inspection, the guide tube 21A is pulled out from the pulling out hole of the outer casing 35Dd. At this time, only the cartridge main body 35Dc inside the outer casing 35Dd is rotated, whereby the outer casing 35Dd can be fixed to a cartridge setting table not shown in the drawing.

Also, with such a construction, the rotating part is not exposed, and thus the rotation operation of the cartridge main body 35Dc, that is, the reliable operation for the sending out operation of the guide tube 21A can be easily secured.

In addition, when the inspection is completed, the lid member 35De is taken out, and the used guide tube 21A is contained inside the guide tube containing section 35Df. After that, the lid member 35De is attached, and while the state is kept as it is, the cartridge 35D can be discarded.

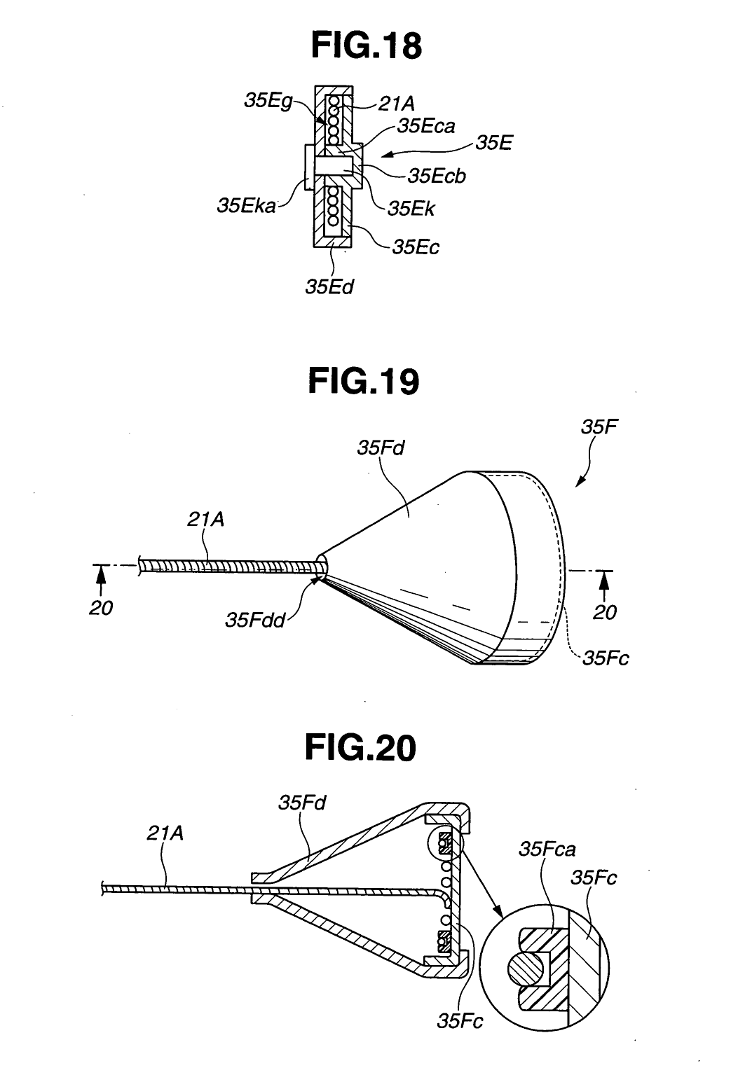

With reference to FIGS. 16 to 18, a further construction of the guide tube containing cartridge will be described.

As shown in FIG. 16 to 18, a cartridge 35E is mainly constructed of a cartridge main body 35Ec and a cover member 35Ed. The cartridge main body 35Ec is substantially shaped into a disc. The cover member 35Ed is arranged so as to cover the cartridge main body 35Ec.

An axis section 35Eca protrudes substantially at the center section of the cartridge main body 35Ec. The guide tube 21A is adapted to be wound about the axis section 35Eca. According to this embodiment, the guide tube 21A is wound about the axis section 35Eca in multiple layers.

A hole section is provided at the center section of the axis section 35Eca. Inside the hole section, an axis member 35Ek for fixing the cover member 35Ed to the cartridge main body 35Ec. In other words, with the provision of the axis member 35Ek, the cartridge main body 35Ec and the cover member 35Ed are integrally attached to each other. While the cartridge main body 35Ec and the cover member 35Ed are integrally attached to each other, a guide tube winding section 35Eg is formed inside thereof.

The cover member 35Ed has a thin cylinder shape having an opening on one side. Substantially at the center of both the sections, a through hole 35 for causing the axis member 35Ek to penetrate is formed. Also, an opening 35Edd formed to have a rectangular shape with a predetermined length is provided at a predetermined area on the peripheral surface of the cover member 35Ed. The opening 35Edd is a pulling out hole 35 for such a case that the guide tube 21A contained inside the cartridge 35E while being wound is pulled out.

Then, a head section 35Eka of the axis member 35Ek protrudes to the outside of the cover member 35Ed in a state in which the axis member 35Ek is attached to the cover member 35Ed and the cartridge main body 35Ec. In correspondence with this, the cartridge main body 35Ec has a small diameter section 35Ecb having substantially the same diameter and the shape as those of the head section 35Eka of the axis member 35Ek substantially at the center section of a surface on the side opposite to the axis section 35Eca side.

While the cartridge main body 35Ec and the cover member 35Ed are integrally attached, the head section 35Eka of the axis member 35Ek and the small diameter section 35Ecb are placed on a predetermined area of a cartridge setting table that is not shown. In the result, the cartridge main body 35Ec constituting the cartridge 35E is set to be freely turnable with respect to the cartridge setting table. In sequence, as the guide tube 21A is pulled out, the cartridge main body 35Ec is rotated on the cartridge setting table, whereby the guide tube 21A is smoothly sent out.

When the inspection is completed, by rotating the cartridge main body 35Ec, the guide tube 21A can be wound back into the guide tube winding section 35Eg of the cartridge 35E. When the winding back is completed, the cartridge 35E as in the same state can be discarded.

In the cartridge 35E constructed in this manner, the shapes of the cartridge main body 35Ec and the cover member 35Ed are revised to realize a thin shape.

Also, with respect to the axis section 35Eca of the cartridge main body 35Ec, the guide tube 21A is wound in the multiple layers inside the guide tube winding section 35Eg, whereby it is possible to align the position of the guide tube 21A to the position of the opening 35Edd in the guide tube winding section 35Eg. In sequence, the sending out of the guide tube 21A can be performed in the stable state.

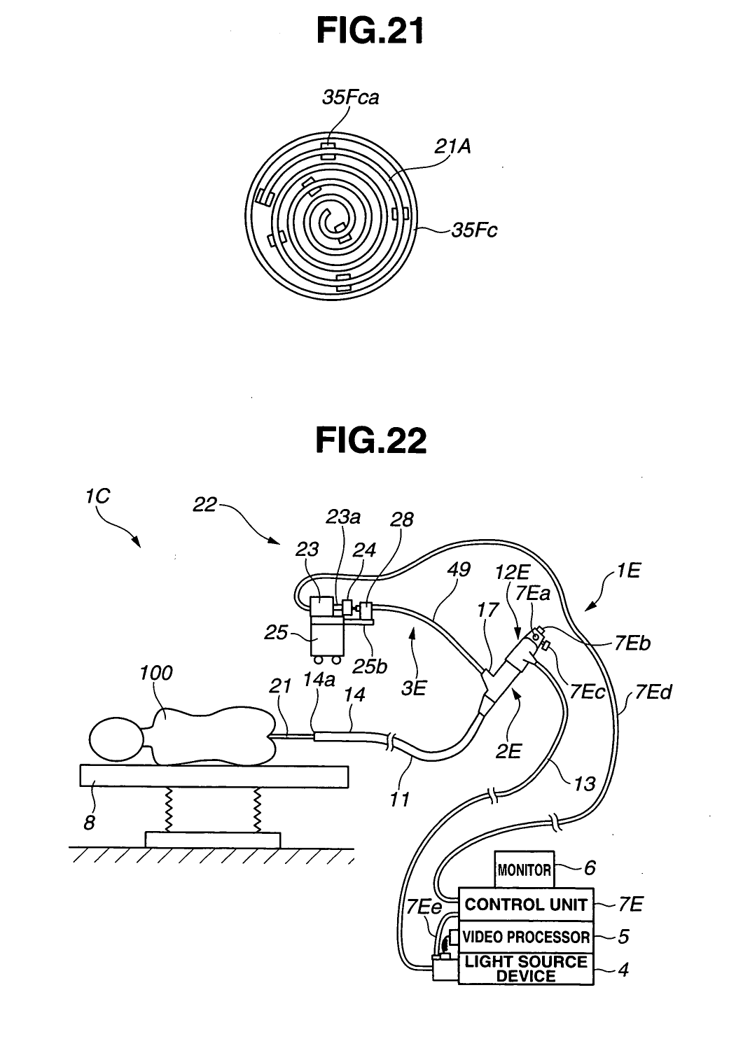

With reference to FIGS. 19 to 21, a further construction of the guide tube containing cartridge will be described.

As shown in FIGS. 19 to 21, a cartridge 35F is mainly constructed of a cartridge main body 35Fc and a cover member 35Fd. The cartridge main body 35Fc constitutes a cylinder section in the assembly state of the cartridge 35F. The cover member 35Fd is composed of a conical shaped section with both end sections opened and a vessel section covering a rim section of a cylindrical section.

The cover member 35Fd is formed to have a conical shape and a through hole 35Fdd for pulling out the guide tube 21A wound inside is formed at its peak section.

On the flat surface inside the cartridge main body 35Fc, a plurality of holding members 35Fca made of a flexible member for holding the guide tube 21A wound in a spiral manner are fixed. As shown in the enlarged cross sectional diagram of FIG. 20, the holding members 35Fca is formed to substantially have a U shape in its cross section. A groove section of the holding members 35Fca is set to have a width size for holding the guide tube 21A in the state of being sandwiched. Also, in the state of sandwiching the guide tube 21A, when the guide tube 21A is pulled to the groove section opening direction of the holding members 35Fca, the guide tube 21A can be easily removed.

By integrally attaching the cartridge main body 35Fc to the cover member 35Fd, the cartridge 35F of this modification example is formed. In the cartridge 35F constructed this manner the flat surface of the cartridge 35F is placed on a floor surface or a fixing member. In the result, the guide tube 21A can be sent out from the through hole 35 Fdd. In sequence, the cartridge setting table becomes unnecessary.

In addition, as the cover member 35Fd is formed to be conical and the through hole 35Fdd is provided at its apex section, when the guide tube 21A is pulled out, the guide tube 21A can be smoothly introduced toward the through hole 35Fdd. In sequence, the sending out of the guide tube 21A can be smoothly performed.

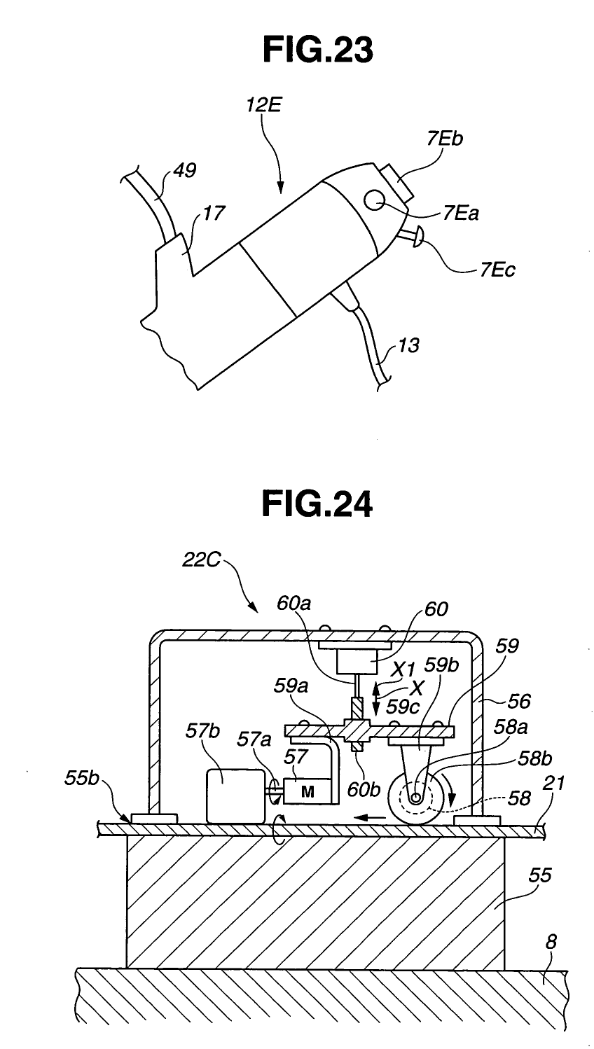

With reference to FIGS. 22 and 23, an endoscopic system according to the fourth embodiment of the present invention will be described.

As shown in FIG. 22, the endoscopic system 1C according to this embodiment is mainly constructed of the endoscope 2E and the insertion device 3E.

The construction of the endoscopic system 1C according to this embodiment is substantially the same as that of the first embodiment as described above. In the endoscopic system 1 C according to this embodiment, the base end section of the guide tube 21 is attached to the guide tube position fix section 24, and thereafter, the distal end section of the guide tube 21 is caused to penetrate the treatment tool insert channel from the treatment tool insert opening 17, thereby protruding from the distal end opening. It should be noted that reference numeral 49 denotes a protection tube, which is disposed between the protection tube holding member 28 and the treatment tool insert opening 17.

In the endoscopic system IC according to this embodiment, instead of the rotation control box 7 according to the first embodiment, a difference point resides in that a control unit 7E is provided. The control unit 7E is a rotation control section for performing, almost similarly to the rotation control box 7 according to the first embodiment, the rotation control on the guide tube 21. An operation member for generating various instruction signals to the control unit 7E is arranged at the operation section 12E of the endoscope 2E.

That is, the operation section 12E of the endoscope 2E includes, as shown in FIG. 23, a plurality of operation members such as the rotation on/off operation member 7Ea, the rotation normal/reverse operation member 7Eb, and the speed adjustment operation member 7Ec at predetermined positions.

The control unit 7E and the guide tube rotation device 22 are electrically connected to each other via a connection cable 7Ed. The control unit 7E and the operation section 12E are electrically connected to each other via the universal code 13 and a connection cable 7Ee.

Therefore, the instruction signals generated while the operation members 7Ea, 7Eb, and 7Ec provided at the operation section 12E are appropriately operated are transmitted from the operation section 12E via the universal code 13 and a connection cable 7Ee to the control unit 7E.

Other constructions are similar to those of the first embodiment, the same reference numerals are given to the same members, and the description thereof will be omitted.

The actions of the endoscopic system 1C according to this embodiment will be described.

A preparation procedure for inserting the guide tube 21 and the insert section 11 of the endoscope 2E to the large bowel will be described.

To insert the insert section 11 of the endoscope 2E to the vermiform appendix section of the large bowel, for example, the staff prepares a protection tube 49 and the guide tube 21 having a desired insertability. Next, the staff fixes one end section of the protection tube 49 to the protection tube holding member 28. Then, the staff causes the guide tube 21 to penetrate the protection tube 49 and an inner hole of the treatment tool insert channel 11a provided at the insert section 11 of the endoscope 2E, the base end section of the guide tube 21 protruding from the protection tube 49 is attached to the guide tube position fix section 24. After that, the control unit 7E, the light source device 4, the video processor 5, and the monitor 6 are put into the on state. As a result, the preparation for inserting the insert section 11 of the endoscope 2E to the large bowel via the guide tube 21 is completed.

A procedure for inserting the insert section 11 of the endoscope 2E into the large bowel via the guide tube 21 will be described.

As shown in FIG. 22, the distal end area of the guide tube 21 protruding from the distal end opening of the treatment tool insert channel provided at the insert section 11 is grasped. After that, from the anus of the patient lying on the bed 8, the distal end section of the guide tube 21 is inserted into the large bowel. Then, as in the first embodiment, the rotating guide tube 21 moves forward along the respective walls of the intestinum rectum 72, the sigmoid colon 73, the descending colon section 74, the transverse colon section 75, and the ascending colon 78. At this time, as shown in FIG. 4, without changing the running state of the large bowel, for example, the guide tube reaches the vicinity of the vermiform appendix section 79 that is the target area.

When the operator judges that the guide tube 21 reaches the vicinity of the vermiform appendix section 79, the operator operates a rotation on/off operating member 7Ea provided at the operation section 12E of the endoscope 2E\. Then, the rotation drive state of the motor 23 of the guide tube rotation device 22 is switched to the off state.

It should be noted that as described above, during the insert operation for inserting the guide tube 21 to the large bowel, the operator appropriately operates the rotation on/off operation member 7Ea, the rotation normal/reverse operation member 7Eb, the speed adjustment operation member 7Ec, and the like provided at the operation section 12E of the endoscope 2E as needed.

Next, in order to insert the insert section 11 into the large bowel, the distal end rigid section 14 of the insert section 11 in the endoscope 2E is inserted from the anus 71 into the large bowel. After that, as in the first embodiment, the operator checks the extending direction of the guide tube 21 inserted into the large bowel on the monitor 8. Then, while the operator conducts the operation for bending the bending section 15, the operation for twisting the insert section 11, and the like, as shown in FIG. 6, the distal end rigid section 14 of the insert section 11 is inserted to the deep section of the large bowel. At this occasion, the operator smoothly inserts the distal end rigid section 14 of the insert section 11 to the vicinity of the vermiform appendix section 79 without losing the insertion direction.

In this manner, while the guide tube is penetrated to the treatment tool insert channel provided at the insert section, this guide tube is penetrated up to the target area of the large bowel. In the result, after the guide tube is penetrated up to the target area, a procedure for causing the guide tube to penetrate the treatment tool insert channel can be omitted. In sequence, the time from the insertion start of the guide tube to the insert start of the insert section is shortened. It should be noted that other actions and effects are similar to those of the first embodiment.

Also, instead of using the rotation control box 7, the control unit 7E is provided, and in accordance with this a plurality of operation sections for generating predetermined instruction signals are provided at the operation section 1 2E of the endoscope 2E. For this reason, the operation for conducting the rotation control on the guide tube 21 can be easily performed by the operator at its hands. In sequence, the insert operation can be executed with higher safety, reliability, and efficiency.

It should be noted that an operation member independent from the control unit 7E may be additionally connected. In this case, it is conceivable that the operation member independently provided includes, for example, a foot-operated switch. For example, the foot switch is adapted to generate an emergency stop instruction signal. In the result, while the operator uses both hands to perform operations and inspection, when the movement of the guide tube 21A is desired to be stopped for any reason, by stamping on the foot-operated switch, the operation of the insertion device can be stopped in emergency. In addition, in the first embodiment and the second embodiment as well, the foot-operated switch can be separately provided and connected to the rotation control box. Furthermore, the emergency stop operation member may be provided on the operation board of the rotation control box.

With reference to FIG. 24, the construction of the guide tube rotation device in the case in which an emergency stop operation member will be described.

The endoscopic system according to this embodiment is substantially the same as those of the first and fourth embodiments as described above in principle According to this embodiment, the guide tube rotation device is adapted to be operated by the emergency stop operation member. In sequence, regarding the other constructions, the first and fourth embodiments as described above are referred to, and the same reference numerals are given to the same constructions. The detailed description thereof will be omitted.

The guide tube rotation device 92C of the insertion device in the endoscopic system according to this embodiment is adapted to rotate the guide tube 21 and also move the guide tube 21 in a straight manner. Therefore, as shown in FIG. 24, the guide tube rotation device 22C is mainly constructed of a device main body section 55, a device cover section 56, a guide tube rotation motor (hereinafter referred to as the first monitor) 57, a guide tube sending motor (hereinafter referred to as the second monitor) 58, and an emergency stop motor (hereinafter referred to as the third monitor) 60. At a predetermined area of the upper flat surface of the device main body section 55, a guide tube arrangement groove 55b to which the guide tube 21 is arranged is formed.

The first motor 57 is a motor for rotating the guide tube 21 that is arranged at the guide tube arrangement groove 55b about the axis. A rotation roller 57b is fixed and arranged at a motor axis 57a of the first motor 57. The rotation roller 57b has a predetermined flexibility. The second motor 58 is a motor for moving the guide tube 21 that is arranged at the guide tube arrangement groove 55b in the guide tube axis direction at a predetermined speed in a straight manner. A forward movement motor 88b is fixed and arranged at a motor axis 58a the second motor 58. The forward movement motor 88b has a predetermined flexibility The motor axis 57a of the first motor 57 is arranged at a position so as to be parallel to an upper flat surface 55a of the device main body section 55 and also parallel to a groove 55b. Whereas the motor axis 58a of the second motor 58 is arranged at a position so as to be parallel to the upper flat surface 55a of the device main body section 55 and also perpendicular to the groove 55b. The first motor 57 is fixed and arranged at a predetermined position of a hoisting attachment 59 by a first fitting 59a. Then, the second motor 58 is also fixed and arranged at a predetermined position of the hoisting attachment 59 by a second fitting 59b.

Therefore, the rotation roller 57b abuts against the guide tube 21 with a predetermined pressure force, and in this state, the first motor 57 is driven. In the result, the rotation roller 57b is rotated in a predetermined direction and the guide tube 21 is rotated about the axis. On the other hand, the forward movement motor 58b abuts against the guide tube 21 with a predetermined pressure force, and in this state, the second motor 58 is driven. In the result, the forward movement motor 58b is rotated in a predetermined direction and the guide tube 21 moves in a straight manner.

Meanwhile, the third motor 60 is a motor for moving the hoisting attachment 59 in the X direction shown in FIG. 24. The third motor 60 is fixed and arranged to the top surface of the device cover section 56. A screw member 60b is fixed to the distal end section of a motor axis 60a of the third motor 60. A member 60b is threadably mounted to a screw section 59c formed at a predetermined position of the hoisting attachment 59. In sequence, the third motor 60 is driven and the screw member 60b fixed to the motor axis 60a is turned in the predetermined direction, thereby moving the hoisting attachment 59 in the X direction shown in FIG. 24.

Other constructions are almost the same as those of the endoscopic system of the first embodiment or the fourth embodiment. In addition, the actions in which the guide tube 21 is inserted to the large bowel, and thereafter an endoscope (2) is inserted to the large bowel are almost the same as those of the endoscopic system of the first embodiment or the fourth embodiment.

Meanwhile, in the endoscopic system of this embodiment, the actions when the emergency stop operation member is operated are as follows.

During the use of the endoscopic system like a case where the guide tube 21 is inserted to the large bowel, for any reason, the operator operates an emergency stop operation member (not shown in the drawing) such as a rotation control box or a foot-operated switch.

At this time, first of all, the first motor 57 and the second motor 58 are stopped. As a result, the rotation and the forward movement of the guide tube 21 are stopped. In this state, the rotation roller 57b and the forward movement motor 58b abut against the guide tube 21. For this reason, the guide tube 21 is fixed at a position where both the motors 57 and 58 stop.

After the stop of the first motor 57 and the second motor 58, subsequently, the third motor 60 is driven. Then, the screw member 60b fixed to the motor axis 60a of the third motor 60 rotates in the predetermined direction, whereby the hoisting attachment 59 moves in the X1 direction shown in FIG. 24. As a result, the first motor 57 and the second motor 58 which are integrally fixed to the hoisting attachment 59 move in the same direction. Then, the rotation roller 57b and the forward movement motor 58b are separated from the guide tube 21 and the contact state is released. In other words, the guide tube 21 can move freely.

As described above, according to the fourth embodiment, when the emergency stop operation member is operated, the first motor 57 and the second motor 58 are stopped, and thereafter the third motor 60 is driven. In the result, the contact state between the rotation roller 57b and the forward movement motor 58b, and the guide tube 21 is released. In sequence, during the use of the endoscopic system, by operating the emergency stop operation member, the operations for the rotation and the forward movement of the guide tube 21 are immediately stopped, and also the guide tube 21 can be set free.

Incidentally, according to the fourth embodiment, there is realized a mechanism in which as the emergency stop operation member is conducted, the drive of the guide tube 21 is stopped, and thereafter the guide tube 21 is set free.

In this case, it is also possible to construct in such a manner for use that an automatic/manual switching operation member is provided separately from the emergency stop operation member and for example, an automatic operation in which the movement of the guide tube 21 is performed by a motor and a manual operation the guide tube 21 is manually moved are switched over.

Then in this case, according to the completely construction as that shown in FIG. 24, with the revision on the drive control on the first, second, and third motors 57, 58, and 60, this can be realized easily.

According to the first, second, or fourth embodiment, the rotation control section such as the rotation control box or the control system uses a connection cable or the like to connect devices to each other. However, the connection means between the devices is not limited to the connection cable or the like, and a remote control system may be applied. In the remote control system, for example, wireless communication means using an infrared ray or the like transmits various instructions signals to predetermined control devices. As a result, the number of various cables for connecting the devices to each other can be reduced. Accordingly, there is an effect in which the degree of freedom in laying the various devices can be enhanced.

According to the above-mentioned embodiments, regarding the control on the rotation speed and the rotation direction of the guide tube, for example, the following control is conducted whereby more reliably operations can be achieved.

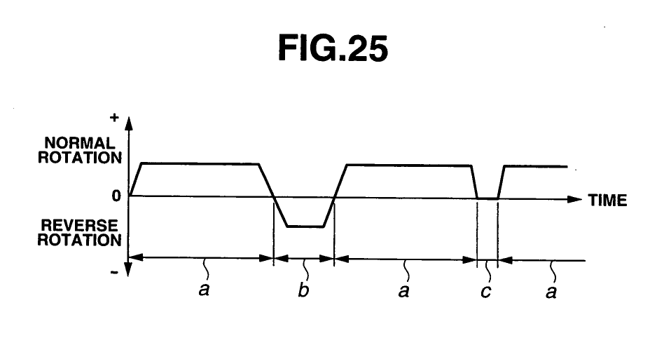

While referring to FIG. 25, a control pattern on the guide tube will be briefly described below.

It should be noted that the horizontal axis represents a time axis and the vertical axis represents a rotation direction of the guide tube in the drawing. Herein, plus (+ in the drawing) shows a case in which normal rotation of the guide tube is performed, and in this case, the guide tube moves forward. On the other hand, minus (− in the drawing) shows a case in which reverse rotation of the guide tube is performed, and in this case, the guide tube moves back. Then, zero (0 in the drawing) represents the rotation stop state of the guide tube.

First of all, the guide tube is rotated and driven. Then, from the zero point to the plus direction, the drive is performed for a predetermined time a. After the drive direction is changed to the minus direction, the drive is performed for a predetermined time b. Herein, such a relation is set to have the time a>the time b.

Furthermore, after the drive direction is performed in the plus direction for the predetermined time a, the stop state is effected for a time c. After this stop time c elapses, the drive in the plus direction is performed again for the time a. After that, the same operations are repeatedly performed subsequently.

A program for describing such a control pattern is stored in a memory section constituting a control section of the guide tube rotation device in advance. In the result, it is possible to perform the rotation operation with the same operation pattern all the time.

It should be noted that the control pattern shown in the drawing merely represents an example. The control pattern is not limited to this, and it is conceivable to have various control patterns. Furthermore, a plurality of such control patterns may be previously prepared, and a preferable control pattern may be selected in accordance with the application of the endoscopic system. Also, a control pattern is freely prepared by a user, and the control pattern prepared by each user is used for operating the endoscopic system.

In this manner, with the revision of the rotation speed of the guide tube and the control pattern of the rotation direction, the endoscopic system can be operated with higher safety and reliability.

It should be noted that the present invention is not limited to the above-mentioned embodiments, and various modifications can be implemented without departing from the gist of the invention.

What is claimed is:

1. An insertion device, comprising:
a long insert section inserted to a subject body;
a propulsion force generation section provided at an outer circumferential surface of the insert section;
a rotation section having a guide tube rotation device for rotating the insert section at which the propulsion force generation section is provided about a longitudinal axis; and
a rotation control section for controlling the rotation section.

2. The insertion device according to claim 1, wherein the propulsion force generation section is formed of a spiral section.

3. The insertion device according to claim 1, wherein the distal end section of the insert section includes observation means for observing the subject body.

4. The insertion device according to claim 1, wherein the rotation control section includes at least one or a plurality of operation members and a drive control on the rotation section is performed in accordance with an instruction signal generated when the operation member is operated.

5. The insertion device according to claim 4, wherein the operation member can perform an on/off control on the rotation section of the guide tube rotation device.

6. The insertion device according to claim 4, wherein the operation member can perform a rotation direction control on the insert section by the rotation section of the guide tube rotation device.

7. The insertion device according to claim 4, wherein the operation member can perform a rotation speed control on the insert section by the rotation section of the guide tube rotation device.

8. The insertion device according to claim 4, wherein the operation member comprises an emergency stop operation member.

9. The insertion device according to claim 8, wherein the emergency stop operation member comprises a foot-operated switch.

10. The insertion device according to claim 8, wherein the emergency stop operation member is operated to perform the off control on the rotation section of the guide tube rotation device and at the same time to release a connection with the insert section in the guide tube rotation device.

11. The insertion device according to claim 1, wherein the rotation section of the guide tube rotation device performs a drive control on the insert section with a control pattern previously determined.

12. An endoscopic system, comprising:
an insert section including a spiral section on an outer circumferential surface and having a flexibility;
a rotation section of a guide tube rotation device for rotating the insert section in a predetermined direction about a longitudinal axis;
a rotation control section for controlling a rotation state of the insert section by controlling the rotation section of the guide tube rotation device; and
an endoscope having a channel at the insert section which the insert section inserted into a body cavity can penetrate or extrapolate along the insert section inserted into the body cavity.

13. The endoscopic system according to claim 12, wherein the endoscope includes at least one or a plurality of operation members, a drive control on the rotation section of the guide tube rotation device is performed via the rotation control section in accordance with an instruction signal generated when the operation member is operated.

14. The endoscopic system according to claim 12, wherein the operation member can perform any one of an on/off control on the rotation section of the guide tube rotation device, a control on the rotation direction of the insert section by the rotation section of the guide tube rotation device, and a control on the rotation speed of the insert section by the rotation section of the guide tube rotation device.
